(19) United States
(12) Patent Application Publication
(10) Pub. No.: US 2022/0124224 A1
(43) Pub. Date: Apr. 21, 2022

(54) DEVICES AND METHODS FOR PROVIDING VIEWING TARGETS FOR USAGE WITH MINIATURIZED CAMERAS

(71) Applicant: Mark Allen Quinn, San Jose, CA (US)

(72) Inventor: Mark Allen Quinn, San Jose, CA (US)

(21) Appl. No.: 17/072,821

(22) Filed: Oct. 16, 2020

(51) Int. Cl. H04N 5/225; G06T 7/73

(52) U.S. Cl. CPC H04N 5/2252; G06T 2207/30201; G06T 7/73

(57) ABSTRACT

An apparatus for use with a miniaturized camera includes: a planar structure having first side and a second side opposite from the first side, wherein the planar structure has an opening sized and shape to allow the miniaturized camera to view therethrough; graphics on the first side of the planar structure, wherein the graphics is configured to provide a viewing target, wherein the opening has a positional relationship with respect to the graphics, and is configured to allow the miniaturized camera to complement with the graphics when the opening of the planar structure is placed in alignment with the miniaturized camera.

### FIELD

The field relates to miniaturized cameras, and more particularly, to apparatuses and methods for providing view targets for usage with miniaturized cameras.

### BACKGROUND

Miniaturized cameras are widely used in electronic devices. For examples, mobile phones, tablets, computers, and laptops generally have miniaturized cameras built therein. Miniaturized cameras may also include webcams that are accessories configured to attach to electronic devices (such as laptops, mobile phones, tablets, etc.). In some cases, miniaturized cameras in the electronic devices can be used to provide facetime communication, such as facetime calls, web conferencing, etc.

Sometimes when a user is using a miniaturized camera for facetime communication, the user may not look at the region where the miniaturized camera is located. This may be due to the fact that the miniaturized camera generally has a color that blends in with a housing of the electronic device. As a result, the user may not be conscientious about the location of the camera, and may forget to look at the camera during the facetime communication. This may cause some annoyance to the recipient of the camera images at the other end of the facetime communication, because the facetime image received by the recipient will show the user not maintaining eye-contact with the recipient (as a result of the user not looking at the camera).

Also, sometimes when a user uses the miniaturized camera on a device to take picture, the person (the user himself or herself, or another person) for which the picture is being taken may not be looking at the miniaturized camera. This may be due to the fact that the miniaturized camera is quite small, and may not be easily noticed or viewed at (especially if the person for which the picture is being taken is further away from the miniaturized camera).

New apparatuses and methods for providing viewing targets for usage with miniaturized cameras are described herein.

### SUMMARY

An apparatus for use with a miniaturized camera includes: a planar structure having first side and a second side opposite from the first side, wherein the planar structure has an opening sized and shape to allow the miniaturized camera to view therethrough; and graphics on the first side of the planar structure, wherein the graphics comprises a facial image configured to provide a viewing target, wherein the opening is located in the facial image.

Optionally, the opening of the planar structure is configured to allow the miniaturized camera to define at least a part of an eye image for the facial image when the opening of the planar structure is placed in alignment with the miniaturized camera.

Optionally, the opening of the planar structure is configured to allow the miniaturized camera to define at least a part of an eyewear image for the facial image when the opening of the planar structure is placed in alignment with the miniaturized camera.

Optionally, the facial image does not have a nose image, or has a partial nose image.

Optionally, the opening of the planar structure is configured to allow the miniaturized camera to define at least a part of a nose image for the facial image when the opening of the planar structure is placed in alignment with the miniaturized camera.

Optionally, the facial image does not have a mouth image, or has a partial mouth image.

Optionally, the opening of the planar structure is configured to allow the miniaturized camera to define at least a part of a mouth image for the facial image when the opening of the planar structure is placed in alignment with the miniaturized camera.

Optionally, the facial image comprises a mouth image, and the opening is located below the mouth image.

Optionally, the opening of the planar structure is configured to allow the miniaturized camera to define at least a part of a hair image for the facial image when the opening of the planar structure is placed in alignment with the miniaturized camera.

Optionally, the opening of the planar structure is configured to allow the miniaturized camera to define at least a part of a headwear image for the facial image when the opening of the planar structure is placed in alignment with the miniaturized camera.

Optionally, the facial image comprises an eye region; and wherein the opening is located at a first elevation with respect to the planar structure, the eye region is located at a second elevation with respect to the planar structure, and wherein a distance between the first elevation and the second elevation is less than 3.5 cm.

Optionally, the distance between the first elevation and the second elevation is less than 5 mm.

Optionally, the apparatus further includes a securing mechanism on the second side of the planar structure.

Optionally, the planar structure comprises a camera cover.

Optionally, the camera cover has a first region for covering the miniaturized camera, and a second region with the opening.

Optionally, the camera cover is slidable to reach at least a first position and a second position, wherein when the camera cover is at the first position, the first region covers the miniaturized camera, and wherein when the camera cover is at the second position, the opening is aligned with the miniaturized camera.

Optionally, the camera cover is slidable to reach a third position, wherein when the camera cover is at the third position, the miniaturized camera is unblocked by any part of the camera cover, and the opening is not aligned with the miniaturized camera.

An apparatus for use with a miniaturized camera includes: a planar structure having first side and a second side opposite from the first side, wherein the planar structure has an opening sized and shape to allow the miniaturized camera to view therethrough; graphics on the first side of the planar structure, wherein the graphics is configured to provide a viewing target, wherein the opening has a positional relationship with respect to the graphics, and is configured to allow the miniaturized camera to complement with the graphics when the opening of the planar structure is placed in alignment with the miniaturized camera.

Optionally, the graphics comprises at least a part of a logo or at least a part of a trademark.

Optionally, the graphics comprises at least a part of a symbol, at least a part of a graphical pattern, or at least a part of an art piece.

Optionally, the graphics comprises at least a part of a facial image.

Optionally, the graphics comprises at least a part of a word, or at least a part of a letter.

Optionally, the graphics comprises at least a part of a photo.

An apparatus for use with a miniaturized camera includes: a planar structure having first side and a second side opposite from the first side, wherein the planar structure has an opening sized and shape to allow the miniaturized camera to view therethrough; a word or a letter on the first side of the planar structure, wherein the opening is located before the word or the letter, is located after the word or the letter, or has an outline forming a part of the word or forming at least a part of the letter.

Optionally, the outline of the opening forms a letter “O”.

Other and further aspects and features will be evident from reading the following detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings illustrate the design and utility of embodiments, in which similar elements are referred to by common reference numerals. In order to better appreciate how advantages and objects are obtained, a more particular description of the embodiments will be described with reference to the accompanying drawings. Understanding that these drawings depict only exemplary embodiments and are not therefore to be considered limiting in the scope of the claimed invention.

FIG. 1 illustrates an apparatus for use with a miniaturized camera in accordance with some embodiments.

FIG. 2A illustrates a device with a miniaturized camera.

FIG. 2B illustrates the device of FIG. 2A, particularly showing the apparatus of FIG. 1 being used with the miniaturized camera.

FIG. 2C illustrates a method of using the device of FIG. 2A.

FIGS. 3A-3C illustrate variations of the apparatus of FIG. 1 in accordance with different embodiments, particularly showing the opening located in an eye region of a facial image.

FIG. 3D illustrates the apparatus of FIG. 3C, particularly showing the apparatus being used with a miniaturized camera.

FIGS. 4A-4H illustrate variations of the apparatus of FIG. 1 in accordance with different embodiments, particularly showing the opening located in a nose region of a facial image.

FIGS. 5A-5D illustrate variations of the apparatus of FIG. 1 in accordance with different embodiments, particularly showing the opening located in a mouth region of a facial image.

FIG. 5E illustrates the apparatus of FIG. 5D, particularly showing the apparatus being used with a miniaturized camera.

FIG. 6 illustrates a variation of the apparatus of FIG. 1, particularly showing the opening located in a chin region of a facial image.

FIG. 7A illustrates a variation of the apparatus of FIG. 1, particularly showing the opening located in a hair region of a facial image.

FIG. 7B illustrates the apparatus of FIG. 7A, particularly showing the apparatus being used with a miniaturized camera.

FIG. 8A illustrates a variation of the apparatus of FIG. 1, particularly showing the opening located in a headwear region.

FIG. 8B illustrates the apparatus of FIG. 8A, particularly showing the apparatus being used with a miniaturized camera.

FIGS. 9A-9J illustrate variations of the apparatus of FIG. 1 in accordance with different embodiments, particularly showing the opening having a positional relationship with respect to the graphics.

FIG. 10 illustrates a variation of the apparatus of FIG. 1, particularly showing the opening having a positional relationship with respect to at least a part of a logo.

FIG. 11 illustrates a variation of the apparatus of FIG. 1, particularly showing the opening having an outline forming a letter.

FIGS. 12A-120 illustrate variations of the apparatus of FIG. 1 in accordance with different embodiments, particularly showing the opening located in front of, or behind, a word.

FIG. 13A illustrates an apparatus having multiple planar structures, each of which being configured for use with a miniaturized camera in accordance with some embodiments.

FIG. 13B illustrates another apparatus having multiple planar structures, each of which being configured for use with a miniaturized camera in accordance with some embodiments.

FIG. 14 illustrates an apparatus having multiple planar structures, each of which being configured for use with a miniaturized camera in accordance with some embodiments.

FIGS. 15A-15C illustrates a camera cover in accordance with some embodiments.

### DESCRIPTION OF THE EMBODIMENTS

Various embodiments are described hereinafter with reference to the figures. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages of the invention shown. An aspect or an advantage described in conjunction with a particular embodiment is not necessarily limited to that embodiment and can be practiced in any other embodiments even if not so illustrated or if not so explicitly described.

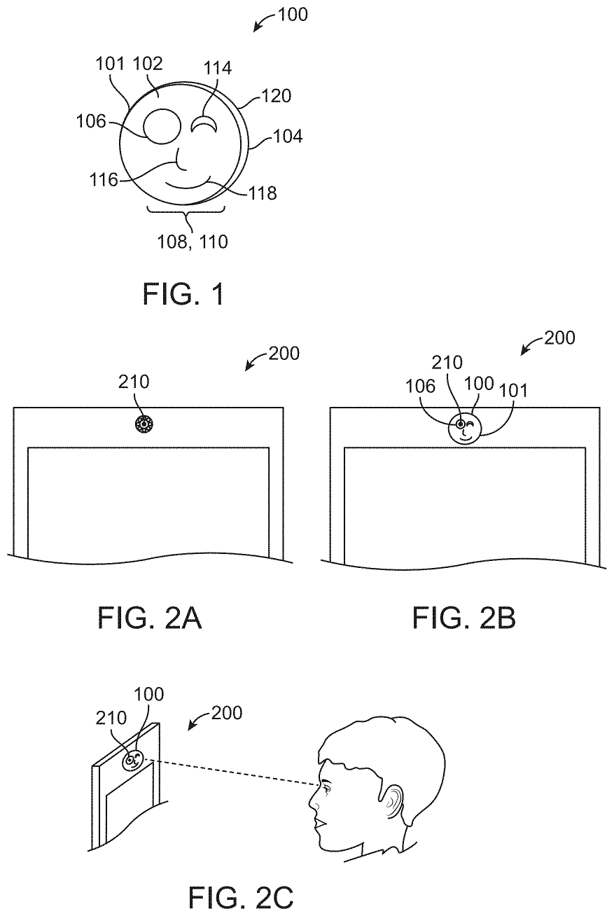

FIG. 1 illustrates an apparatus 100 for use with a miniaturized camera in accordance with some embodiments. The apparatus 100 includes a planar structure 101 having first side 102 and a second side 104 opposite from the first side 102, wherein the planar structure 101 has an opening 106 sized and shape to allow the miniaturized camera to view therethrough. The apparatus 100 also includes graphics 108 on the first side 102 of the planar structure 101. The graphics 108 comprises a facial image 110 configured to provide a viewing target. As shown in the figure, the opening 106 is located in the facial image 110. The apparatus 100 further includes a securing mechanism 120 disposed on the second side 104 of the planar structure 101. The securing mechanism 120 may be an adhesive, cling (e.g., static cling, suction cling, etc.), or any material or mechanism (such as suction cup, clip, clamp, holder, etc.) that is capable of adhering to a surface or coupling to an object. In some embodiments, the apparatus 100 may further include a carrier (e.g., release liner, backing paper, etc.) interfacing the securing mechanism 120, and being configured to detachably couple to the structure 101.

As shown in the figure, the opening 106 has a circular shape. In other embodiments, the opening 106 may have other shapes, such as an elliptical shape, a square shape, a rectangular shape, or any of other shapes.

The apparatus 100 is configured for use with a miniaturized camera. FIG. 2A illustrates a device 200 with a miniaturized camera 210. The device 200 may be a mobile phone, a tablet, a computer, a laptop, or any of other electronic devices. As shown in FIG. 2B, during use of the apparatus 100, the planar structure 101 is secured to a surface of the device 200 via the securing mechanism 120, such that the opening 106 of the planar structure 101 is aligned with the miniaturized camera 210 of the device 200. As shown in the figure, the opening 106 allows the miniaturized camera 210 to view therethrough. Also, because the miniaturized camera 210 has a dark color (e.g., black, or close to black), when the opening 106 of the planar structure 101 is placed in alignment with the miniaturized camera 210, the opening 106 of the planar structure 101 allows the miniaturized camera 210 to define at least a part of an eye image for the facial image 110.

The apparatus 100 with the graphics 108 provides a viewing target for the user who is using the miniaturized camera 210 of the device 200. For example, during web conferencing, the user may look towards the apparatus 100, using the apparatus 100 as a viewing target (FIG. 2C). The graphics 108 around the camera 210 provides an attraction, which attracts the user's attention, making it easier for the user to look at the miniaturized camera 210 during the web conferencing. As a result of the user looking at the graphics 108 of the apparatus 100, participant(s) of the web conferencing will receive video images from the miniaturized camera 210, in which the user of the device 200 has eye-contact with the participant(s). The above features are especially beneficial for children, as they tend not to look at the right direction during video call or web meeting.

The user of the device 200 can also use the apparatus 100 during picture taking. For example, when taking selfie using the miniaturized camera 210, the user may look towards the apparatus 100, using the apparatus 100 as a viewing target. As a result of the user looking at the graphics 108 of the apparatus 100 while taking a selfie, the resulting picture will show the user looking at the camera while the picture is taken. Similarly, when the user uses the device 200 to take a picture of another person, the person may look towards the apparatus 100, using the apparatus 100 as a viewing target. As a result of the person looking at the graphics 108 of the apparatus 100 while taking a selfie, the resulting picture will show the person looking at the camera while the picture is taken. The above features are especially beneficial when taking pictures of children, as they tend not to look at the right direction during picture taking.

The structure 101 may have a thickness that is less than 4 mm, less than 3 mm, less than 2 mm, less than 1 mm, less than 0.5 mm, etc. Also, the opening 106 may have a cross-sectional dimension that is equal to, or larger than, a cross-sectional dimension of an optical window of the miniaturized camera. For example, in some embodiments, the opening 106 may have a cross-sectional dimension that is anywhere from 1 mm to 10 mm, or anywhere from 3 mm to 6 mm, such as less than 5 mm, less than 4 mm, less than 3 mm, less than 2 mm, etc.

In some embodiments, the structure 101 may have an overall cross-sectional dimension (e.g., diameter) that is anywhere from 3 mm to 75 mm, or anywhere from 5 mm to 25 mm. In other embodiments, the structure 101 may have an overall cross-sectional dimension that is different from the above examples.

The structure 101 may be made from a variety of different materials, including but not limited to plastic, paper, polymer, metals, alloys, carbon fiber, cling material(s), etc. Also, the apparatus 100 may be made from different techniques in different embodiments. For example, in some embodiments, a sheet of material is provided, and graphics 108 may be provided on the sheet of material. The sheet of material is then cut to create the perimeter of the structure 101. The sheet of material is also cut to create one or more edges defining the opening 106. In some cases, the graphics 108 may be printed onto the sheet of material. Alternatively, the graphics 108 may be disposed onto the sheet of material using deposition technique.

It should be noted that the apparatus 100 is not limited to the configuration shown in the example of FIG. 1, and that the apparatus 100 may have different configurations in different embodiments.

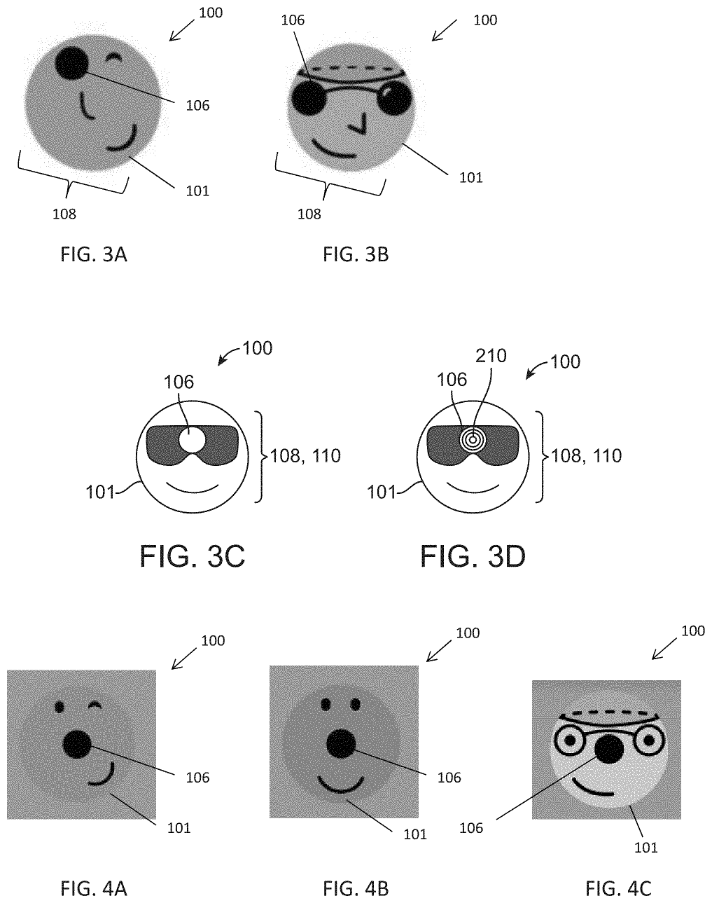

In some embodiments, the graphics 108 may have a color that is different from a color of the device with the miniaturized camera. This allows the graphics 108 to stand out to attract the user's attention and/or to make it easier for the user to notice and to look at the apparatus 100 as a viewing target. For example, in some embodiments, the graphics 108 of the apparatus 100 may have a green color (FIG. 3A). In other embodiments, the graphics 108 of the apparatus 100 may have other colors, such as blue, red, white, yellow, orange, purple, white, black, or any combination of two or more of the foregoing.

In other embodiments, the opening 106 of the planar structure 101 may be configured to allow the miniaturized camera to define at least a part of an eyewear image for the facial image when the opening 106 of the planar structure 101 is placed in alignment with the miniaturized camera (FIG. 3B). In the illustrated example, the eyewear image is an image of a pair of sunglasses.

In other embodiments, instead of the eyewear image being am image of a pair of sun glasses, the eyewear image may be an image of a pair of goggles (FIG. 3C). FIG. 3D illustrates the apparatus 100 of FIG. 3C, particularly showing the apparatus 100 being used with a miniaturized camera 210. As shown in the figure, because the miniaturized camera 210 has a dark color, when the opening 106 of the planar structure 101 is placed in alignment with the miniaturized camera 210, the opening 106 of the planar structure 101 allows the miniaturized camera 210 to define at least a part of an image of the googles.

In further embodiments, the eyewear image may be an image of any article placed over an eye, such as an eye-patch, an eye-cover, etc.

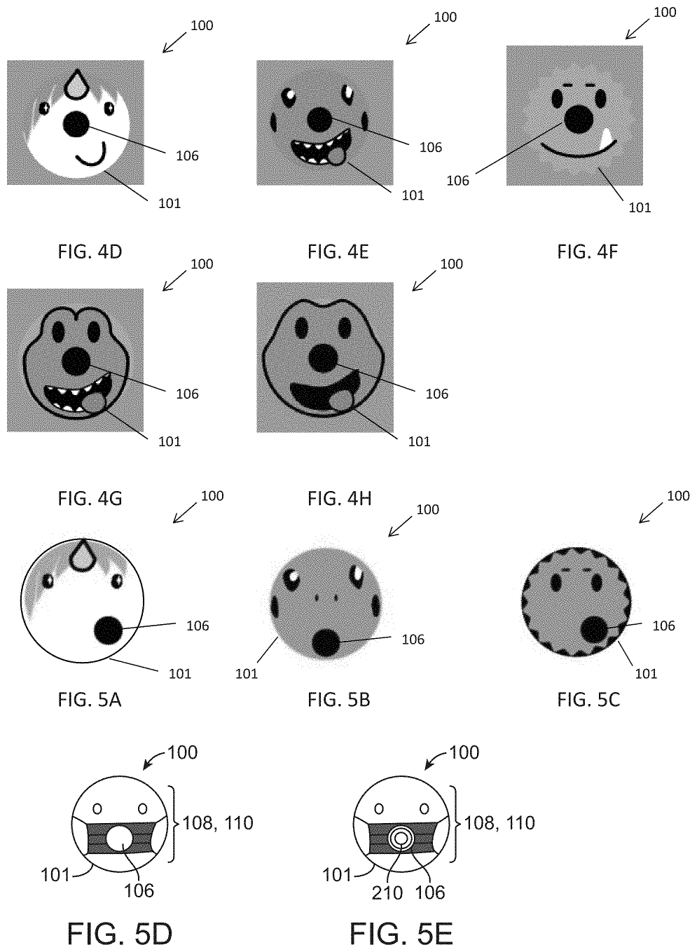

In other embodiments, instead of having the opening 106 of the planar structure 101 located in the eye region of the facial image 110, the opening 106 of the planar structure 101 may be located in a nose region of the facial image 110. FIGS. 4A-4H illustrate variations of the apparatus 100 of FIG. 1 in accordance with different embodiments, particularly showing the opening 106 located in a nose region of a facial image. As shown in each of FIGS. 4A-4H, because the opening 106 is located in the nose region of the facial image, the facial image does not have a nose image. Alternatively, the facial image may have a partial nose image. For example, in other embodiments, the facial image of the apparatus 100 may have an outline of a nose image, wherein the opening 106 is located within the outline. In such cases, the area between the opening 106 and the outline of the nose image may have a color, such as black, dark blue, dark green, etc. The opening 106 of the planar structure 101 is configured to allow a miniaturized camera to define at least a part of a nose image (e.g., a part of the nose image, or a complete nose image) for the facial image when the opening 106 of the planar structure 101 is placed in alignment with the miniaturized camera.

In other embodiments, the opening 106 of the planar structure 101 may be located in a mouth region of the facial image 110. FIGS. 5A-5D illustrate variations of the apparatus 100 of FIG. 1 in accordance with different embodiments, particularly showing the opening 106 located in a mouth region of the facial image 101. In the examples shown in FIGS. 5A-5C, the opening 106 is configured to allow a miniaturized camera to form an image of a mouth for the facial image 110. As shown in each of FIGS. 5A-5C, because the opening 106 is located in the mouth region of the facial image, the facial image does not have a mouth image. Alternatively, the facial image may have a partial mouth image. For example, in other embodiments, the facial image of the apparatus 100 may have an outline of a mouth image, wherein the opening 106 is located within the outline. In such cases, the area between the opening 106 and the outline of the mouth image may have a color, such as black, dark blue, dark green, etc. The opening 106 of the planar structure 101 is configured to allow a miniaturized camera to define at least a part of a mouth image (e.g., a part of the nose image, or a complete nose image) for the facial image when the opening 106 of the planar structure 101 is placed in alignment with the miniaturized camera.

In the example shown in FIG. 5D, the opening 106 is configured to allow a miniaturized camera to form an image of a facemask for the facial image. FIG. 5E illustrates the apparatus 100 of FIG. 5D, particularly showing the apparatus 100 being used with a miniaturized camera 210. As shown in the figure, because the miniaturized camera 210 has a dark color, when the opening 106 of the planar structure 101 is placed in alignment with the miniaturized camera 210, the opening 106 of the planar structure 101 allows the miniaturized camera 210 to define a part of an image of the facemask. In other words, the miniaturized camera 210 completes the image of the facemask by filling in the space defined by the opening 106 in the image of the facemask.

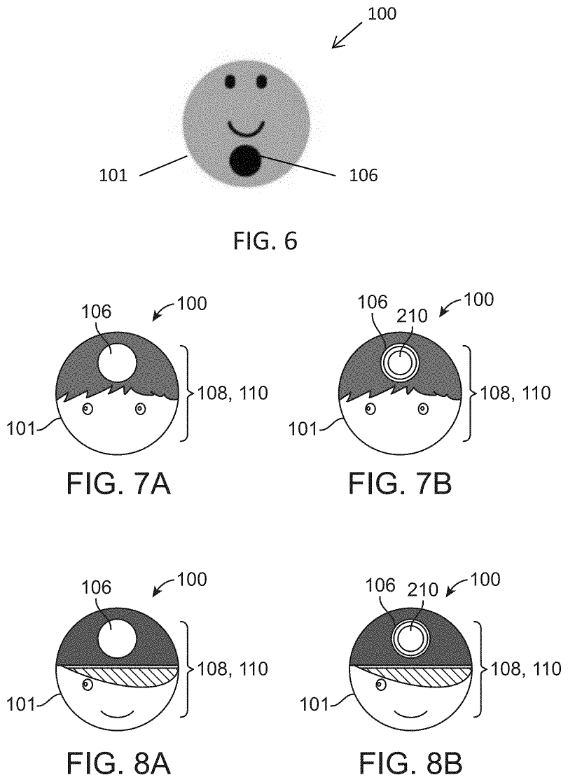

In other embodiments, the opening 106 of the planar structure 101 may be located in a chin region of the facial image. FIG. 6 illustrates a variation of the apparatus 100 of FIG. 1, particularly showing the opening 106 located in a chin region of the facial image 110. The opening 106 of the planar structure 101 is configured to allow a miniaturized camera to define at least a part of a chin image (e.g., a part of the chin image, or a complete chin image) for the facial image when the opening 106 of the planar structure 101 is placed in alignment with the miniaturized camera. In other embodiments, the chin region of the facial image may include a beard image. In such cases, the opening 106 may be located in the beard image.

In other embodiments, the opening 106 of the planar structure 101 may be located in a hair region of the facial image 110. FIG. 7A illustrates a variation of the apparatus 100 of FIG. 1, particularly showing the opening 106 located in a hair region of the facial image 110. FIG. 7B illustrates the apparatus 100 of FIG. 7A, particularly showing the apparatus 100 being used with the miniaturized camera 210. As shown in the figure, because the miniaturized camera 210 has a dark color, when the opening 106 of the planar structure 101 is placed in alignment with the miniaturized camera 210, the opening 106 of the planar structure 101 allows the miniaturized camera 210 to define a part of an image of the hair in the facial image 110. In other words, the miniaturized camera 210 completes the image of the hair by filling in the space defined by the opening 106 in the image of the hair.

In other embodiments, the opening 106 of the planar structure 101 may be located in a headwear region of the facial image 110. FIG. 8A illustrates a variation of the apparatus 100 of FIG. 1, particularly showing the opening 106 located in a headwear region. FIG. 8B illustrates the apparatus 100 of FIG. 8A, particularly showing the apparatus 100 being used with the miniaturized camera 210. As shown in the figure, because the miniaturized camera 210 has a dark color, when the opening 106 of the planar structure 101 is placed in alignment with the miniaturized camera 210, the opening 106 of the planar structure 101 allows the miniaturized camera 210 to define a part of an image of the headwear (headwear image) in the facial image 110. In other words, the miniaturized camera 210 completes the image of the headwear by filling in the space defined by the opening 106 in the image of the headwear. In the illustrated example, the image of the headwear is in a form of a cap. In other examples, the image of the headwear may be an image of a hat, an image of a sport helmet, an image of a headband, an image of a bike helmet, an image of a motorbike helmet, an image of a fencing helmet, an image of a headset, an image of a ski mask, etc. Also, it should be noted that the term “headwear”, as used in this specification, may refer to any object for wear at any part of a head (including but not limited to forehead, ear, nose, mouth, etc.) of a user. Thus, an image of a headwear may include an image of a pair of eye-glasses, an image of a pair of sun-glasses, an image of a pair of googles, an image of a facemask, an image of a bandana, etc.

In some embodiments in which the opening 106 is implemented at a certain location at the planar structure 101 so that the miniaturized camera can “fill in” certain graphical element (such as the goggle image of FIG. 3C, the facemask image of FIG. 5D, the hair image of FIG. 7A, the cap image of FIG. 8A, etc.), it may be desirable to provide such graphical element with a color that closely matches the color of the miniaturized camera. The color of the graphical element is considered as “closely matches” the color of the miniaturized camera if a first color metric value M1 (e.g., first color wavelength) measuring a characteristic of the color of the graphical element is within 20% of a second color metric value M2 (e.g., second color wavelength) measuring a characteristic of the color of the miniaturized camera. This allows the camera to “blend in” with the graphical element (i.e., M1=any value between 0.8×M2 and 1.2×M2). Since miniaturized cameras may have a black color, a grey color, or a dark blue color, in some embodiments, the graphical element in the graphics 108 of the apparatus 100 where the opening 106 is located may have a black color, a grey color, or a dark blue color. In other embodiments, the graphical element in the graphics 108 where the opening 106 is located may have any of other colors.

Also, in other embodiments, the color of the graphical element in the graphics 108 where the opening 106 is located may not match the color of the miniaturized camera. For example, the color of at least a part of the graphical element extending from the edge of the opening 106 may have a color that is different from a color of the camera. In some embodiments, the color of the graphical element is considered as different from the color of the camera if a first color metric value M1 (e.g., first color wavelength) measuring a characteristic of the color of the graphical element is different from a second color metric value M2 (e.g., second color wavelength) measuring a characteristic of the color of the miniaturized camera. Alternatively, the color of the graphical element is considered as different from the color of the camera if a first color metric value M1 (e.g., first color wavelength) measuring a characteristic of the color of the graphical element differs from a second color metric value M2 (e.g., second color wavelength) measuring a characteristic of the color of the miniaturized camera by more than a certain percentage, such as 10%, 15%, 20%, 30%, etc.

In the above embodiments, the graphics 108 of the apparatus 101 is illustrated as having a facial image 110. The facial image 110 with the opening 106 of the apparatus 100 is advantageous because it is configured so that the opening 106 allows the miniaturized camera to complement (e.g., integrate) with the facial image 110. The facial image 110 provides an easy-to-view target for the user because eye-contact with respect to the camera is easier to achieve when there is a face associated with the camera. Also, because the opening 106 allows the miniaturized camera to complement with the facial image 110, the miniaturized camera is “camouflaged” by the graphics 108 to some extent. This also allows the user to look at the miniaturized camera easier because the user may not notice or even remember that he or she is looking into a camera.

Although the opening 106 may be implemented at any region of the facial image 110, implementing the opening 106 at the eye region (e.g., where the opening 106 allows the miniaturized camera to form at least a part of the eye or eyewear for the facial image 110) of the facial image 110 is particularly more advantageous. This is because the eye region is the natural target place for a person to look when communicating with another person. Accordingly, if the opening 106 is implemented at the eye region of the facial image 110, when the user looks at the eye region of the facial image 110, the user will be looking directly at the miniaturized camera. Implementing the opening 106 at the nose region or forehead region of the facial image 110 has similar advantageous as the “eye region” embodiments, as long as the opening 106 is within a certain distance from the eye region of the facial image 110. In some embodiments, the opening 106 may be located at a first elevation with respect to the structure 101, and the eye region of the facial image 110 is located at a second elevation with respect to the structure 101, wherein a distance between the first elevation and the second elevation is anywhere from 1 mm to 3.5 cm, such as less than 2 cm, less than 1 cm, less than 5 mm, less than 3 mm, etc.

In other embodiments, the opening 106 is not limited to the examples described, and may be implemented at other parts of the facial image 110. For example, in other embodiments, the opening 106 may be implemented at an ear region, a cheek region, a jaw region, etc., of the facial image 110.

It should be noted that an anatomical “region” of the facial image 110 refers to a region in the facial image 110 wherein an anatomical feature can be included in that region, but the facial image 110 does not necessarily have an image of the anatomical feature. For example, “eye region” refers to a region in the facial image 110 that is below the forehead, but the eye region of the facial image 110 may not include any image of an eye or eyewear. The same applies for “nose region”, “mouth region”, “chin region”, “ear region”, “cheek region”, “jaw region”, etc.,

It should be noted that the facial image 110 is not limited to an image of a cartoon human face or an image of a cartoon animal face. In other embodiments, the facial image 110 may be an image of any cartoon character. In further embodiments, the facial image 110 may not be a cartoon, and may instead be a photo. For example, in other embodiments, the facial image 110 may be a photo of a person, a photo of an action character, etc.

In other embodiments, instead of a facial image, the graphics 108 of the apparatus 100 may have other images, such as an image of a pattern, an image of an art piece, an image of a letter, an image of a word, an image of a phrase, an image of a logo or a trademark, an image of a photo, etc.

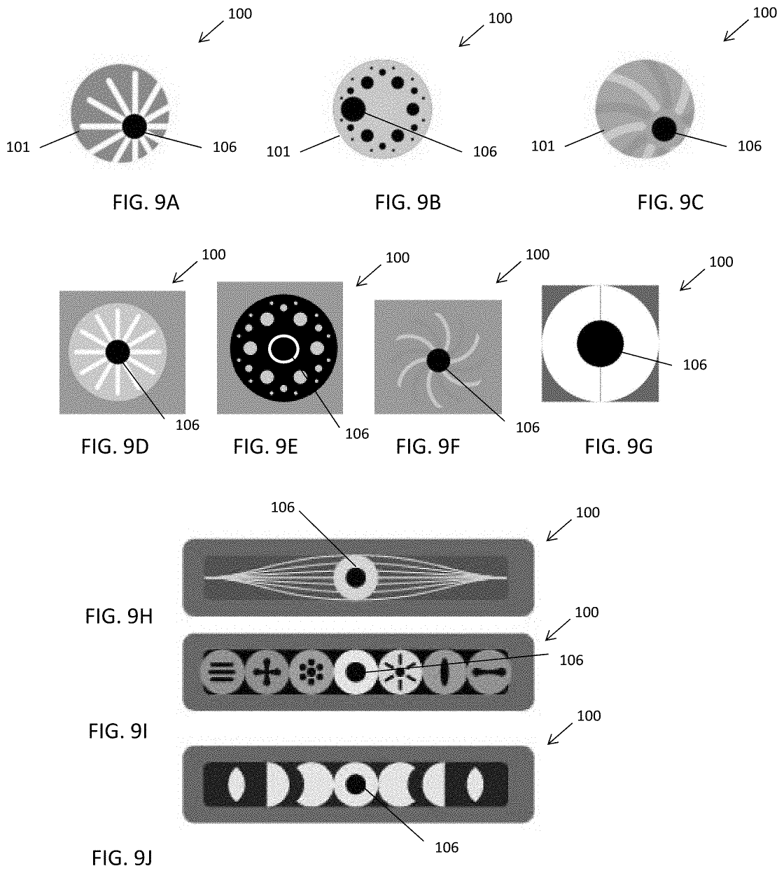

FIGS. 9A-9J illustrate variations of the apparatus 100 of FIG. 1 in accordance with different embodiments, particularly showing the opening 106 having a positional relationship with respect to the graphics 108. The graphics 108 are in the form of a patterns or art pieces in the different embodiments. During use, when the opening 106 of the planar structure 101 is placed in alignment with the miniaturized camera, the opening 106 of the planar structure 101 allows the miniaturized camera 210 to define a part of a pattern or art piece in the graphics 108. In other words, the miniaturized camera 210 completes the pattern or art piece by filling in the space defined by the opening 106 in the graphics 108.

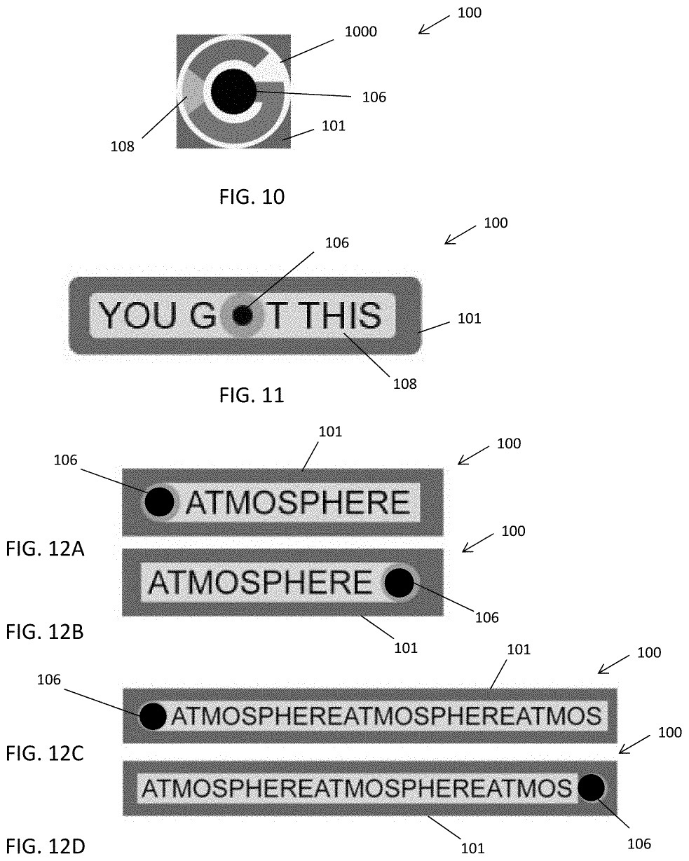

FIG. 10 illustrates a variation of the apparatus 100 of FIG. 1, particularly showing the opening 106 having a positional relationship with respect to at least a part of a logo 1000. As shown in the figure, the opening 106 is located in the center of the logo 1000. In other embodiments, the opening 106 may be located at other positions with respect to the logo 1000. The opening 106 may touch a part of the logo 1000, or may be spaced away from the logo 1000. In some embodiments, a spacing between the opening 106 and the logo 1000 may be anywhere from 1 mm to 10 cm, such as less than 5 cm, less than 4 cm, less than 3 cm, less than 2 cm, less than 1 cm, less than 5 mm, less than 3 mm, etc. In other embodiments, the logo 1000 may be different from the example illustrated. For example, in other embodiments, the logo 1000 may have a shape of an apple. In further embodiments, instead of a logo, the graphics 108 may be an image of a trademark.

FIG. 11 illustrates a variation of the apparatus 100 of FIG. 1, particularly showing the opening 106 having an outline forming a letter. As shown in the figure, the graphics 108 has the text “YOU GOT THIS”, and the opening 106 has an outline forming the letter “O” in the word “GOT”. In other embodiments, the graphics 108 may have different texts, e.g., different words, phrases, sentences. Also, in the illustrated example, the opening 106 is located in the middle of the text. In other embodiments, the opening 106 may be located away from the middle of the text. Furthermore, in other embodiments, instead of the letter “O”, the opening 106 may have an outline forming any of other letters, a part of a letter, a symbol, a part of a symbol, a mathematical operator, a part of a mathematical operator, a language character (e.g., a Chinese character, a Japanese character, etc.), a part of a language character, etc.

FIGS. 12A-120 illustrate variations of the apparatus 100 of FIG. 1 in accordance with different embodiments, particularly showing the opening 106 located in front of (FIG. 12A, FIG. 12C), or behind (FIG. 12B, FIG. 12D), one or more words (e.g., a single word, a series of word, a phrase, a sentence, etc.).

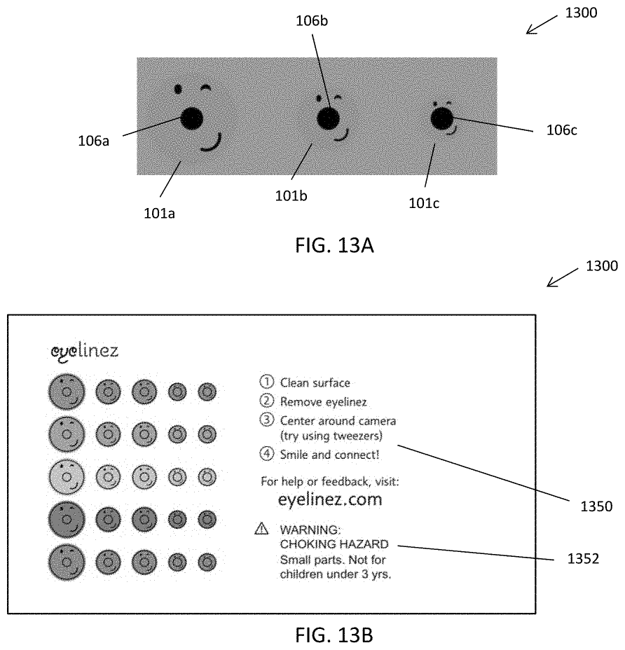

FIG. 13A illustrates an apparatus 1300 having multiple planar structures 101a-101c, each of which being configured for use with a miniaturized camera in accordance with some embodiments. In particular, the planar structures 101a-101c have respective openings 106a-106c, each of which is configured to allow a miniaturized camera to view therethrough. In the illustrated embodiments, the planar structures 101a-101c have different respective sizes. During use, a user can select a desired one of the planar structures 101a-101c, and attach it to a device with the miniaturized camera. Since different devices may have respective miniaturized cameras that are spaced from respective edges of the devices, by providing different planar structures 101a-101c with different sizes, the user can select one that is suitable for a particular device. For example, if a certain device has a miniaturized camera that is located close to an edge of the device, then the user may select the planar structure 101c, for placement around the miniaturized camera, so that the planar structure 101c will not extend beyond the edge of the device. On the other hand, if a miniaturized camera is further away from an edge of a device, then the user may select the planar structure 101a, or the planar structure 101b, for use with such miniaturized camera.

In some embodiments, the planar structures 101a-101c may be respective decals or stickers. The planar structures 101a-101c may be removeably coupled to a carrier (e.g., release liner, backing paper, etc.), which may also be part of the apparatus 1300.

In other embodiments, the openings 106a-106c of the respective planar structures 101a-101c may have different respective sizes and/or shapes. Such feature allows the planar structures 101a-101c to be used with miniaturized cameras with different sizes.

Also, in other embodiments, instead of having three planar structures 101, the apparatus 1300 may have more than three planar structures 101 with respective openings 106 configured for allowing miniaturized camera(s) to view therethrough. In further embodiments, the apparatus 1300 may have fewer than three planar structures 101 (e.g., two planar structures 101) with respective openings 106 configured for allowing miniaturized camera(s) to view therethrough.

In some embodiments, the apparatus 1300 may have planar structures 101 with the same graphics, but the planar structures 101 may have different respective overall dimension, as well as different respective colors (FIG. 13B). The apparatus 1300 may also optionally further include usage instruction 1350 and/or choking hazard labeling 1352.

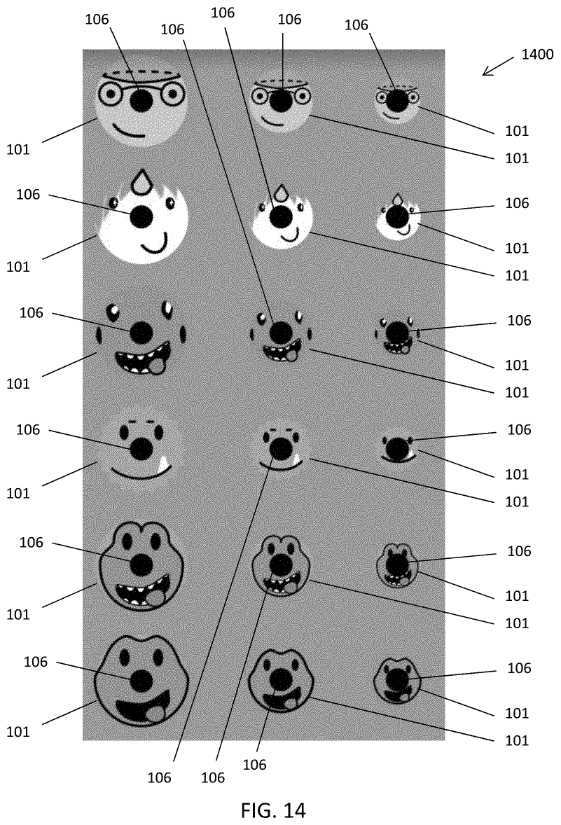

In the above embodiments, the planar structures 101a-101c of the apparatus 1300 have the same graphics, but with different respective sizes. In other embodiments, the apparatus may have planar structures 101 with different respective graphics. FIG. 14 illustrates an apparatus 1400 having multiple planar structures 101, each of which being configured for use with a miniaturized camera in accordance with some embodiments. In the illustrated example, there are different graphics in some of the planar structures 101, but the planar structures 101 have respective openings 106 that are the same size and shape. In other embodiments, at least two of the planar structures 101 may have respective openings 106 of different sizes.

In some embodiments, the planar structures 101 may be respective decals or stickers. The planar structures 101 may be removeably coupled to a carrier (e.g., release liner, backing paper, etc.), which may also be part of the apparatus 1400.

In the above embodiments, the planar structure 101 is described as being configured to attach to, or to couple with, a device so that the opening 106 is aligned with a miniaturized camera of the device. In other embodiments, the planar structure 101 may be configured to attach to, or to couple with a webcam. In further embodiments, the planar structure 101 may be configured to attach to, or to couple with a camera cover of a device.

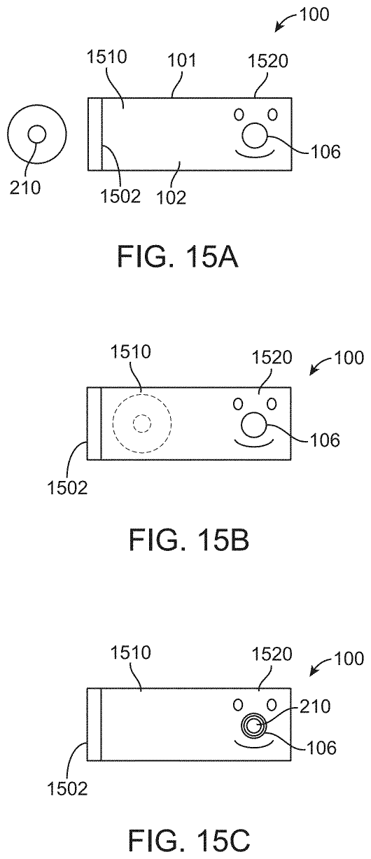

In other embodiments, the planar structure 101 itself may be a camera cover. In such cases, the camera cover may include the opening 106 and the graphics 108 adjacent the opening 106. FIGS. 15A-15C illustrate the apparatus 100, particularly showing the apparatus 100 in the form of a camera cover. The camera cover may be made from plastic, polymer, metal, alloy, or any of other suitable materials known in the art. The apparatus 100 includes a first region 1510 configured to cover the camera 210, and a second region 1520 that includes the opening 106 for allowing the camera 210 to view therethrough. The camera 210 may be a miniaturized camera, such as a webcam in some embodiments. As shown in the figures, the apparatus 100 includes graphics next to the opening 106 configured to function as view target, as described herein. The graphics may be painted on the first side 102 of the structure 101, disposed on the first side 102 using deposition technique, or may be attached to the first side 102. During use, the apparatus 100 (the camera cover in the illustrated embodiments) is moveable (e.g., slidable) to reach at least a first position and a second position. When the apparatus 100 is in the first position, the first region 1510 of the apparatus 100 covers the camera 1510 (FIG. 15B). When the apparatus 100 is in the second position, the second region 1520 with the opening 106 is disposed over the camera 210 so that the camera 210 can view through the opening 106 (FIG. 15C). The graphics next to the opening 106 provides a view target for the user, as described herein. In some embodiments, the apparatus 100 may optionally be configured to be positioned (e.g., slidable) to a third position. When the apparatus 100 is in the third position, the camera 210 is unblocked by any part of the apparatus 100 (camera cover), and the opening 106 is not aligned with the camera 210 (FIG. 15A). In some embodiments, the apparatus 100 may optionally further include a protrusion (e.g., a tab) 1502 that is configured to be engaged by the user's finger for positioning the apparatus 100.

It should be noted that as used in this specification, the term “planar structure” refers to any structure (object) having orthogonal dimensions (first and second dimensions D1, D2 that are orthogonal to each other) that are both larger than a third orthogonal dimension D3. For example, D1, D2 may each be larger than 2×D3, 3×D3, 4×D3, 5×D3, 6×D3, 7×D3, 8×D3, 9×D3, 10×D3, etc. Thus, the term “planar structure” is not limited to a structure that having a thin profile and may include structure with a bulkier configuration. Also, the term “planar structure” is not limited to a structure with a smooth rectilinear surface. For example, the planar structure may be any structure with a textured surface, a surface having protrusion(s) and/or indentation(s), a surface having a curvature, or any combination of the foregoing.

Also, as used in this specification, the term “graphics” refer to any visual information or visual effect that is provided by an apparatus, wherein the visual information or visual effect may be achieved by printing information (e.g., text, shape, lines, etc.) on a surface, depositing material(s) on a surface, molding one or more materials to form visual information or effect, deforming a surface to create the visual information or effect, securing (e.g., gluing, pasting, etc.) materials on the surface, etc. In some embodiments, the material forming the structure 101 may form at least a part of the graphics 108. For example, in some embodiments, the material forming the structure 101 may have a yellow color, and the graphics 108 may include eyes printed on the yellow surface of the structure 101, creating an emoji with a yellow face. In this example, the yellow face (provided by the material of the structure 101) and the eyes graphics together form the graphics 108 that is a yellow emoji. Thus, the term “graphics” is not limited to printed material, and may include any article of manufacture made by any manufacturing process.

In addition, as used in this specification, the term “image” refers to any presentation or visual impression provided by graphics. For example, a graphics may have certain visual information that comprises certain lines. The lines may form a nose image, giving a user's a presentation or visual impression of a nose. Since “graphics” is not limited to printed material and may include any article of manufacture, the term “image” also should not be limited to presentation or visual impression provided by printed material, and may refer to any presentation or visual impression provided by any article of manufacture.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

1. An apparatus for use with at least a part of a miniaturized camera, comprising:
a planar structure having first side and a second side opposite from the first side, wherein the planar structure has an opening sized and shape to allow the miniaturized camera to view therethrough; and
graphics on the first side of the planar structure, wherein the graphics comprises a facial image configured to provide a viewing target, wherein the opening is located in the facial image;
wherein the planar structure has an overall dimension that is less than 75 mm.

2. The apparatus of claim 1, wherein the opening of the planar structure is configured to allow the miniaturized camera to define at least a part of an eye image for the facial image when the opening of the planar structure is placed in alignment with the miniaturized camera.

3. The apparatus of claim 1, wherein the opening of the planar structure is configured to allow the miniaturized camera to define at least a part of an eyewear image for the facial image when the opening of the planar structure is placed in alignment with the miniaturized camera.

4. The apparatus of claim 1, wherein the facial image does not have a nose image, or has a partial nose image.

5. The apparatus of claim 1, wherein the opening of the planar structure is configured to allow the miniaturized camera to define at least a part of a nose image for the facial image when the opening of the planar structure is placed in alignment with the miniaturized camera.

6. The apparatus of claim 1, wherein the facial image does not have a mouth image, or has a partial mouth image.

7. The apparatus of claim 1, wherein the opening of the planar structure is configured to allow the miniaturized camera to define at least a part of a mouth image for the facial image when the opening of the planar structure is placed in alignment with the miniaturized camera.

8. The apparatus of claim 1, wherein the facial image comprises a mouth image, and the opening is located below the mouth image.

9. The apparatus of claim 1, wherein the opening of the planar structure is configured to allow the miniaturized camera to define at least a part of a hair image for the facial image when the opening of the planar structure is placed in alignment with the miniaturized camera.

10. The apparatus of claim 1, wherein the opening of the planar structure is configured to allow the miniaturized camera to define at least a part of a headwear image for the facial image when the opening of the planar structure is placed in alignment with the miniaturized camera.

11. The apparatus of claim 1, wherein the facial image comprises an eye region; and
wherein the opening is located at a first elevation with respect to the planar structure, the eye region is located at a second elevation with respect to the planar structure, and wherein a distance between the first elevation and the second elevation is less than 3.5 cm.

12. The apparatus of claim 11, wherein the distance between the first elevation and the second elevation is less than 5 mm.

13. The apparatus of claim 1, further comprising a securing mechanism on the second side of the planar structure.

14. The apparatus of claim 1, wherein the planar structure comprises a camera cover.

15. The apparatus of claim 14, wherein the camera cover has a first region for covering the miniaturized camera, and a second region with the opening.

16. The apparatus of claim 15, wherein the camera cover is slidable to reach at least a first position and a second position, wherein when the camera cover is at the first position, the first region covers the miniaturized camera, and wherein when the camera cover is at the second position, the opening is aligned with the miniaturized camera.

17. The apparatus of claim 16, wherein the camera cover is slidable to reach a third position, wherein when the camera cover is at the third position, the miniaturized camera is unblocked by any part of the camera cover, and the opening is not aligned with the miniaturized camera.

18. An apparatus for use with at least a part of a miniaturized camera, comprising:
a planar structure having first side and a second side opposite from the first side, wherein the planar structure has an opening sized and shape to allow the miniaturized camera to view therethrough; and
graphics on the first side of the planar structure, wherein the graphics is configured to provide a viewing target, wherein the opening has a positional relationship with respect to the graphics, and is configured to allow the miniaturized camera to complement with the graphics when the opening of the planar structure is placed in alignment with the miniaturized camera;
wherein the planar structure has an overall dimension that is less than 75 mm.

19. The apparatus of claim 18, wherein the graphics comprises at least a part of a logo or at least a part of a trademark.

20. The apparatus of claim 18, wherein the graphics comprises at least a part of a symbol, at least a part of a graphical pattern, or at least a part of an art piece.

21. The apparatus of claim 18, wherein the graphics comprises at least a part of a facial image.

22. The apparatus of claim 18, wherein the graphics comprises at least a part of a word, or at least a part of a letter.

23. The apparatus of claim 18, wherein the graphics comprises at least a part of a photo.

24. An apparatus for use with at least a part of a miniaturized camera, comprising:
a planar structure having first side and a second side opposite from the first side, wherein the planar structure has an opening sized and shape to allow the miniaturized camera to view therethrough; and
a word or a letter on the first side of the planar structure, wherein the opening is located before the word or the letter, is located after the word or the letter, or has an outline forming a part of the word or forming at least a part of the letter.

25. The apparatus of claim 24, wherein the outline of the opening forms a letter “O”.
